(19) United States
(12) Patent Application Publication
(10) Pub. No.: US 2009/0059798 A1
(43) Pub. Date: Mar. 5, 2009

(54) Apparatus for and method of monitoring QoS metrics of VoIP voice traffic using SIP/RTP

(75) Inventors: Youngseok Lee, Yuseong-gu (KR); Hyeongu Son, Dongdaemun-gu (KR)

Correspondence Address: STAAS & HALSEY LLP, SUITE 700, 1201 NEW YORK AVENUE, N.W., WASHINGTON, DC, 20005, US

(73) Assignee: THE INDUSTRY & ACADAMIC COOPERATION IN CHUNGNAM NATIONAL UNIVERSITY, Daejeon (KR)

(21) Appl. No.: 12/149,377

(22) Filed: Apr. 30, 2008

(30) Foreign Application Priority Data
Sep. 4, 2007 (KR) 10-2007-89274

(51) Int. Cl. H04L 12/26

(52) U.S. Cl. 370/241

(57) ABSTRACT

An apparatus for measuring QoS metrics of VoIP voice traffic using SIP and RTP in a router or a network, not in a user terminal, and a method of measuring QoS metrics of VoIP voice traffic using the apparatus.

### CROSS-REFERENCE TO RELATED APPLICATIONS

This application claims the benefit of Korean Application No. 10-2007-09274, filed on Sep. 4, 2007, in the Korean Intellectual Property Office, the disclosure of which is incorporated herein by reference.

### BACKGROUND

1. Field

One or more aspects of the present invention relate to an apparatus for measuring QoS metrics of VoIP voice traffic using SIP and RTP in a router or a network, not in a user terminal, and a method of measuring QoS metrics of VoIP voice traffic using the apparatus.

2. Description of the Related Art

Voice over Internet protocol (VoIP) is a core technique of Internet telephony, in which voice service conventionally provided through a public switched telephone network (PSTN) is provided by transmitting voice data in a digital form using the Internet protocol (IP). As voices are digitalized and transport systems are evolved to use the IP, it is possible to provide advanced telephony services, such as Internet facsimiles, web-calls, integrated message processing, and the like, as well as telephone services. The Internet phone technique using VoIP implements integrated telephone services utilizing existing IP networks as they are, and thus it is advantageous in that telephone users may be provided with long distance and international telephone services in an Internet or Intranet environment by paying only local telephone fees. The VoIP technique that is spotlighted after VocalTec has commercialized an Internet phone in 1995 is generalized as international telephone companies competitively adopt the technique to reduce communication fees. In Korea, Internet phone users are exponentially increased after Saerom Technology has started to provide Dialpad service, i.e., a free international telephone service, for domestic PC users on Jan. 5, 1999.

Since the VoIP technique should be coupled with IP-based private networks, PSTN networks, and hybrid networks combining these, as well as the Internet, standardization of techniques and protocols is important. The most widely used standard protocols are H.323 developed by International Telecommunication Unit (ITU-T) and Session Initiation Protocol (SIP) developed by International Engineering Task Force (IETF). Among these, the SIP is widely used as a protocol for transferring signal messages for a VoIP telephone call at the current moment and is spotlighted as a next generation VoIP signaling method after being adopted as the official standard of IETF in 1999.

Real-time transport protocol (RTP) is a transport layer protocol capable of transmitting streaming traffic such as voices or moving images through the Internet, which is designed appropriately to transmit real-time data so as to provide multimedia services such as video on demand (VoD), audio on demand (AoD), and VoIP.

Generally, traffic monitoring in a communication network is indispensable for detecting abnormal traffic and providing quality of service (QoS) based on the traffic monitoring. VoIP voice traffic using SIP/RTP generally includes traffic for transmitting SIP signal messages and voice traffic using RTP. In order to support traffic monitoring in a large scale network, a method of measuring traffic at a flow level, not a packet level, is useful. It is since that the method of monitoring traffic at a flow level may be embedded in a router or a switch while reducing the amount of traffic measurement data and maintaining accuracy of traffic measurement. A VoIP RTP voice flow is defined as a set of IP packets sharing five fields (IP address of a transmitter, IP address of a receiver, port number of the transmitter, port number of the receiver, and protocol). In order to detect the VoIP RTP voice flow within a router or a network, the IP addresses and port numbers of the transmitter and receiver are identified by analyzing a SIP signal message.

In a conventional method of measuring QoS metrics of VoIP voice traffic, voice traffic is artificially generated using a terminal or a test node that is used instead of the terminal, and the voice traffic received by an opponent terminal is analyzed. However, it is not easy to install specific software in a user terminal and monitor QoS of VoIP voice traffic in a commercial VoIP network. Furthermore, overheads are big to simultaneously monitor a large number of terminals.

IETF IPFIX (IP flow information export) is a standard related to IP flow measurement and transmission for classifying IP packets received through a router or a traffic distributor into flows and flexibly managing creation and termination time of a flow, the numbers of packets and bytes, and the like. Accordingly, if the flow is monitored using IPFIX in a VoIP network, QoS of VoIP voice traffic is expected to be measured by an apparatus in a router or a network.

### SUMMARY

Additional aspects and/or advantages will be set forth in part in the description which follows and, in part, will be apparent from the description, or may be learned by practice of the invention.

Therefore, an aspect of the present invention to provide an apparatus for monitoring QoS metrics of VoIP voice traffic using SIP/RTP in a router or a network, not in a user terminal.

Another aspect of the invention is to provided a method of measuring QoS metrics of VoIP voice traffic using the apparatus of the invention, in which QoS metrics such as a throughput, delay time, jitter, loss rate, and the like are measured by observing VoIP voice traffic using SIP/RTP in a router without installing additional software in a user terminal, and the QoS metrics are measured by observing only user traffic without generating additional measurement traffic.

According to one aspect of the present invention, there is provided an apparatus for detecting and analyzing a VoIP RTP voice flow of VoIP RTP voice traffic using a SIP/RTP protocol, comprising (A) a SIP message detection unit for distinguishing a SIP message from an inputted IP packet and extracting information on a VoIP RTP flow from the SIP message; (B) a VoIP RTP flow management unit for receiving the VoIP RTP flow extracted by the SIP message detection unit, and calculating and storing state information of the VoIP RTP flow; and (C) a VoIP RTP flow transmission unit for transmitting the state information of the VoIP RTP flow calculated by the VoIP RTP flow management unit to a VoIP traffic QoS monitoring server.

According to another aspect of the present invention, there is provided a method of monitoring QoS metrics of VoIP voice traffic using the apparatus for detecting and analyzing a VoIP RTP voice flow, the method comprising the steps of: (1) receiving state information of a VoIP RTP flow transmitted from the apparatus and separating corresponding information; (2) storing the received state information of the VoIP RTP flow in a flow DB; and (3) visualizing the state information of the VoIP RTP flow stored in the flow DB.

According to the present invention described above, QoS metrics of VoIP voice traffic using SIP/RTP protocols may be measured in a router or a network, not in a terminal. Accordingly, a VoIP service provider may effectively use the present invention to examine VoIP QoS metrics at a variety of points in a network and calculate base data for improving performance.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view schematically showing a process of analyzing QoS metrics by detecting VoIP voice traffic using SIP/RTP from a network in the process of transmitting voice traffic using VoIP.

FIG. 2 is a view showing an apparatus for detecting and analyzing VoIP voice traffic using SIP/RTP in a router or a network according to an embodiment of the present invention.

FIG. 3 is a view showing an apparatus for storing and visualizing a result of analysis on QoS metric of VoIP voice traffic using SIP/RTP according to an embodiment of the present invention.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

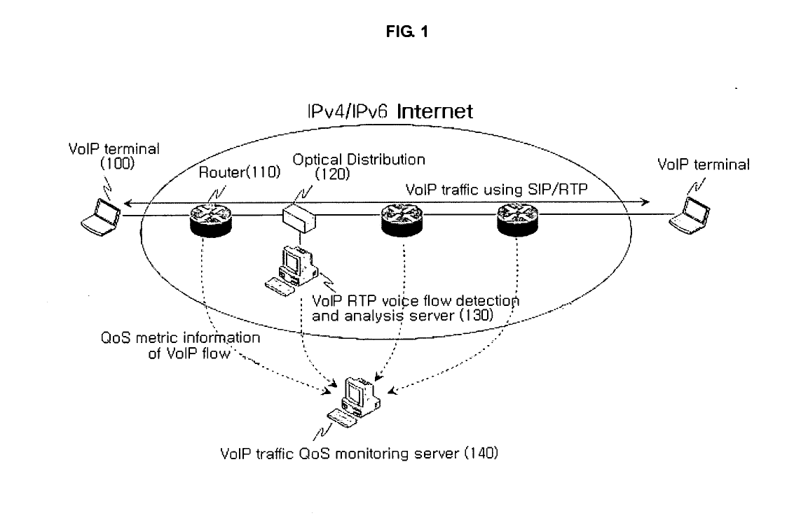

FIG. 1 is a view schematically showing a process of analyzing QoS metrics by detecting VoIP voice traffic using SIP/RTP from a network in the process of transmitting voice traffic using VoIP. Referring to FIG. 1, a VoIP terminal 100 is connected to an IPv4 or IPv6 Internet network, and transmits and receives voice traffic to and from an opponent VoIP terminal using SIP and RTP protocols. A VoIP RTP voice flow detection and analysis server 130, which is the apparatus of the present invention capable of capturing traffic of a specific link using a router 110 or an optical distributor 120 installed between the VoIP terminals, extracts VoIP RTP voice flow information, such as IP addresses and port numbers of a transmitter and a receiver, from a SIP message. Using the extracted VoIP RTP voice flow information, QoS metric information of the VoIP RTP voice flow is analyzed and transmitted to a VoIP traffic QoS monitoring server 140. In the description of FIG. 1, although the apparatus of the present invention is described in the form of an independent VoIP RTP voice flow detection and analysis server 130 as an example, the apparatus of the present invention may be applied as an apparatus embedded in an IPv4 or IPv6 router.

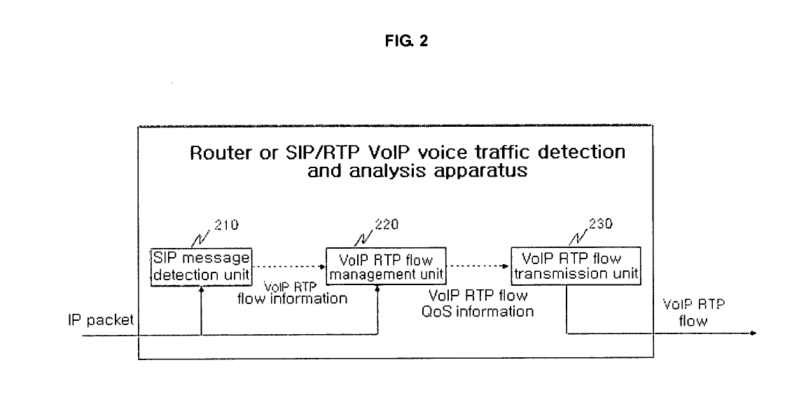

FIG. 2 is a view showing an apparatus for receiving IP packets from a network, detecting VoIP flows using SIP/RTP, and obtaining QoS metrics of the VoIP flows according to the present invention. The apparatus may be implemented as a function of a router or as an independent apparatus using an optical distributor. First, a SIP message detection unit 210 receives IP packets, identifies SIP messages, and extracts VoIP flow information from the SIP messages. It is assumed that the SIP message uses a port that is well-known by a port number 5060. The VoIP RTP flow information extracted from the SIP message comprises IP addresses and port numbers of the transmitter and the receiver, and is transmitted to a VoIP RTP flow management unit 220. The VoIP RTP flow management unit 220 performs operations of creating, maintaining, and deleting a state of the detected RTP flow, calculates QoS metrics such as a throughput, delay time, jitter, loss rate, and the like, and stores the QoS metrics in each flow state. The VoIP RTP flow management unit 220 records information on the time of creation and recent update of the RTP flow, a throughput of a packet transmission rate and a bit transmission rate per hour, minimum, average, and maximum delays of arrival time between packets, and a deviation of the delay times as a jitter. In addition, the VoIP RTP flow management unit 220 calculates a packet loss rate using the sequence number in the RTP packet header and the number of received packets. VoIP RTP flow state information includes QoS metric information, as well as information on the IP addresses and port numbers of the transmitter and the receiver, a protocol, and the like that can distinguish a flow. The VoIP RTP flow state information is managed by the router or the VoIP RTP voice flow detection and analysis server. The VoIP RTP flow state information is transmitted to the VoIP traffic QoS monitoring server 140 by a VoIP RTP flow transmission unit 230 when the flow is deleted or periodically. The IETF IPFIX standard is used for the format of the VoIP RTP flow state message.

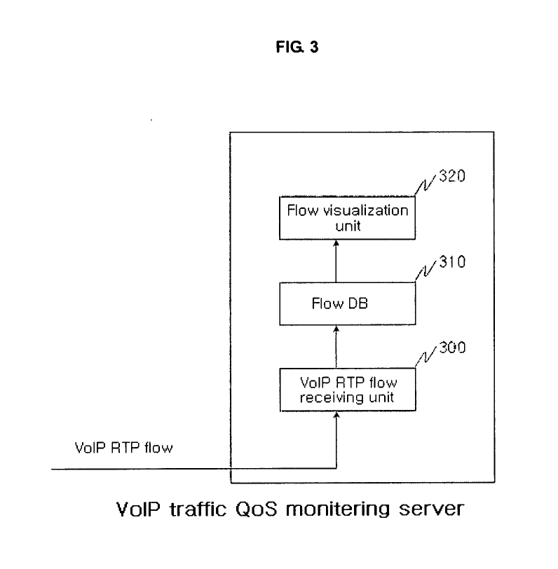

FIG. 3 is a view showing the structure of the VoIP traffic QoS monitoring server. A receiving unit 300 examines whether VoIP RTP flow state information, which is transmitted from a router embedded with the apparatus according to the invention or an independent VoIP RTP voice flow detection and analysis server according to the invention, is transmitted in a proper IETF IPFIX format and separates corresponding message information. The received VoIP RTP flow state information is stored in a flow DB 310 and visualized in the form of a graph by a flow visualization unit 320, and thus QoS metrics of VoIP traffic can be monitored.

According to an aspect of the present invention, QoS metrics of VoIP voice traffic using SIP/RTP protocols may be measured in a router or a network, not in a terminal. Accordingly, a VoIP service provider may effectively use the present invention to examine VoIP QoS metrics at a variety of points in a network and calculate base data for improving performance.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An apparatus for detecting and analyzing a VoIP RTP (Voice over Internet Protocol Real-time protocol) voice flow of VoIP RTP voice traffic using a SIP/RTP (Session Internet Protocol/Real-time protocol) protocol, the apparatus comprising:
a SIP message detection unit to distinguish a SIP message from an inputted IP packet and extracting information on a VoIP RTP flow from the SIP message;
a VoIP RTP flow management unit to receive the VoIP RTP flow extracted by the SIP message detection unit, and calculating and storing state information of the VoIP RTP flow; and
a VoIP RTP flow transmission unit to transmit the state information of the VoIP RTP flow calculated by the VoIP RTP flow management unit to a VoIP traffic QoS (Quality of Service) monitoring server.

2. The apparatus according to claim 1, wherein the apparatus is embedded in a router.

3. The apparatus according to claim 1, wherein the apparatus is in the form of an independent server on a network.

4. The apparatus according to claim 1, wherein a format of the state information of the VoIP RTP flow is an IETF IPFIX (International Engineering Task Force IP flow information export) standard format.

5. The apparatus according to claim 2, wherein a format of the state information of the VoIP RTP flow is an IETF IPFIX standard format.

6. The apparatus according to claim 3, wherein a format of the state information of the VoIP RTP flow is an IETF IPFIX standard format.

7. The apparatus according to claim 1, wherein the state information of the VoIP RTP flow includes a throughput of a packet transmission rate per hour and a bit transmission rate per hour, minimum/average/maximum delays of arrival time between packets and a deviation of the delay times, and a packet loss rate.

8. The apparatus according to claim 2, wherein the state information of the VoIP RTP flow includes a throughput of a packet transmission rate per hour and a bit transmission rate per hour, minimum/average/maximum delays of arrival time between packets and a deviation of the delay times, and a packet loss rate.

9. The apparatus according to claim 3, wherein the state information of the VoIP RTP flow includes a throughput of a packet transmission rate per hour and a bit transmission rate per hour, minimum/average/maximum delays of arrival time between packets and a deviation of the delay times, and a packet loss rate.

10. A method of monitoring QoS (Quality of Service) metrics of VoIP (Voice over Internet Protocol) voice traffic, the method comprising:
receiving state information of a VoIP RTP (Voice over Internet Protocol Real-time protocol) flow transmitted from the apparatus for detecting and analyzing a VoIP RTP voice flow according to claim 1 and separating corresponding information;
storing the received state information of the VoIP RTP flow in a flow DB (Data Base); and
visualizing the state information of the VoIP RTP flow stored in the flow DB.
